(19) United States
(12) Patent Application Publication
(10) Pub. No.: US 2024/0188194 A1
(43) Pub. Date: Jun. 6, 2024

(54) HIGH DENSITY ELECTRIC FURNACE HEATING MODULE

(71) Applicant: GPRE IP, LLC, St. Louis, MO (US)

(72) Inventors: Baldeep K. Dogra, Thane (IN); John M. Peterman, Troy, MO (US)

(73) Assignee: GPRE IP, LLC, St. Louis, MO (US)

(21) Appl. No.: 18/529,174

(22) Filed: Dec. 5, 2023

Related U.S. Application Data
(60) Provisional application No. 63/430,461, filed on Dec. 6, 2022.

(51) Int. Cl. H05B 3/64; H05B 3/06

(52) U.S. Cl. CPC H05B 3/64; H05B 3/06

(57) ABSTRACT

A heating module for a furnace with a process zone. The module includes one or more Silicon Carbide heating elements in a refractory plug. The heating lengths of the elements extend, exposed, from the plug and do not engage one another, but may be positioned to cross over each other. The plug is releasably positioned in the furnace with the heating lengths exposed to the process zone. The plug can be positioned in an array of heating modules, which can be releasably positioned in the furnace with the heating lengths exposed to the process zone.

### CROSS REFERENCE TO RELATED APPLICATIONS

This application derives and claims priority from U.S. provisional application 63/430,461, filed Dec. 6, 2022, and having Attorney Docket No. GILP H010US, which provisional application is incorporated herein by reference.

### STATEMENT REGARDING FEDERALLY SPONSORED RESEARCH OR DEVELOPMENT

Not applicable.

### BACKGROUND OF THE INVENTION

This invention relates principally to an electric high-density heating device or module for a high temperature furnace, and more particularly to a modular heating device for such furnaces in which each device comprises either one or a plurality of high-density electric Silicon Carbide (“SiC”) heating elements.

It is common in the high temperature furnace industry to utilize electrical metallic resistance heating elements in molten aluminum holding furnaces or in other high-temperature equipment to maintain the molten metals at desired temperatures during operating processes. Electric-type metallic resistance elements consist of a high-temperature resistance alloy, often a Nickel-Chrome alloy, a Silicon Carbide, or an Iron Chrome Aluminum alloy, that is usually formed in sinuous loops or coils. The metallic heating elements may be supported in the furnace in a variety of configurations. For example, the heating elements can be configured to project into the furnace from the furnace sidewalls on refractory or alloy hooks, or attached to rods or poles. Alternatively, the heating elements may be suspended from the furnace roof with hangers or hooks of various designs and material composition. In some cases, the heating elements may be laid on the floor of the furnace, for example in comb-type refractory ceramic insulators.

One problem with utilization of metal or alloy heating elements is that the life of the metallic heating element can be substantially reduced by the process environment in the furnace. For example, certain components in the furnace atmosphere surrounding the heating elements can attack and degrade the metals and/or alloys that make up the heating elements. Such components may be introduced into the furnace by the incoming gas or may be outgassed by the product (i.e., scrap) entering the furnace, and may include, e.g., salts, fluxes, sulfur, and various oxidizers that can attack the fragile electric metal heating elements and cause them to fail. However, the timing of each individual heating element failure is not wholly predictable.

Because it is well-recognized in the industry that metallic heating elements routinely fail in high temperature furnaces at unpredictable times, designers and engineers typically design such furnaces with twice as many metallic electric heating elements as are needed for proper operation of the furnace processes. This is done to lengthen the time between maintenance cycles or repair outages, which constitute costly downtime periods for the furnace. Unfortunately, there are drawbacks associated with incorporating more heating elements than would otherwise be required.

First, placing twice as many heating elements in a furnace that are actually needed at any given time essentially doubles the cost of those components.

Further, metallic heating elements in close proximity to one another can cause heat flux issues that adversely impact the operation and longevity of the metallic elements. For example, due to the large number of elements in limited space within the furnace, the heating elements are very closely packed together. Such a concentration of heating elements causes the heat flux from each element to directly impact its neighboring and nearby heating elements. This results in the generation of hotspot zones in which the elements are unable to adequately dissipate their collective heat and energy, which further shortens the lifespan of the heating elements.

In addition, molten metal splashes are common in aluminum furnaces, particularly when operations clean them. These splashes can impact the heating element causing additional oxidation, insulating the element and causing it to burn out early. This can exacerbate or even create hotspot zones in the closely packed heating elements.

Moreover, due to the nature of the metallic electric heating element being constructed of flexible wire, the complete element is traditionally built on and around insulators constructed substantially of ceramics. Typically, these fragile assemblies are placed in an alloy metal tube to protect the wire. These heating element tube assemblies are then placed in the furnace. In addition, many high-temperature metallic alloys used for heating elements suffer from poor ductility and brittleness, especially after they have been at their operating temperature for any length of time and then brought back down to room temperature. Removing and replacing the heating element tube assemblies is a very time-consuming process and, usually, cannot be done while the process equipment is hot and/or in operation. Thus, the furnace has to be shut down and cooled to remove and replace the damaged or failing unit(s). However, replacement raises the risk of damaging the other, equally fragile, heating element tube assemblies packed in proximity to the one being replaced.

The composition of high temperature heating elements is also significant. Compared with other traditional metallic or metal-alloy heating elements, heating elements constructed of Silicon Carbide (“SiC”) offer increased operating temperatures. For example, SiC heating elements are often used in heat treatment of metals, the melting of glass and non-ferrous metal, ceramics, float glass production, electronics components manufacturing, pilot lights, gas heater igniters, etc. For furnace temperatures up to 1600° C., SiC elements can often provide rapid heating and exceptionally long service life. SiC heating elements are therefore desirable. However, the use of SiC has its limitations. In particular, traditionally, SiC elements are installed as a straight bar or rod in the furnace. However, this poses a problem as the SiC elements can only be manufactured in short lengths, limiting the size and capacity of the furnace processes that utilize SiC heating elements. Further, such devices are traditionally installed in fixtures in the furnace walls, which requires more time and effort to maintain and/or replace.

It would therefore be desirable to have a SiC heating element component in a modular configuration for ease of maintenance and/or replacement. Further, it would be desirable to have such a modular SiC heating element that produces adequate heat flux while reducing or minimizing the need for closely packing adjacent heating element components and that provides for ready replacement of such heating elements in the case of failure or routine maintenance. As will become evident in this disclosure, the present invention provides such benefits over the existing art.

### BRIEF DESCRIPTION OF THE DRAWINGS

The illustrative embodiments of the present invention are shown in the following drawings which form a part of the specification:

FIG. 1 is a perspective view of a first embodiment of a SiC heating element module, incorporating various features of the present invention;

FIG. 2 is a perspective view of the “U-shaped” SiC heating element of the heating element module of FIG. 1;

FIG. 3 is perspective view of a plurality of SiC heating element modules, of the type presented in FIG. 1, arranged in a horizontal matrix or array for placement in a high temperature furnace;

FIG. 4 is a perspective view of a second embodiment of a SiC heating element module, incorporating various features of the present invention;

FIG. 5 is a perspective view of the heating element module of FIG. 4, but having only one of two “U-shaped” heating elements positioned in the module;

FIG. 6 is a side plan view of the heating element module of FIG. 4;

FIG. 7 is perspective view of the refractory plug, mounting plate and support brackets of the heating element module of FIG. 4;

FIG. 8 is a perspective view of two of the “U-shaped” SiC heating elements of the heating element module of FIG. 4, oriented as if positioned in the heating element module;

FIG. 9 is perspective view of a plurality of SiC heating element modules, of the type presented in FIG. 4, arranged in a horizontal matrix or array for placement in a high temperature furnace;

FIG. 10 is an alternate perspective view of the matrix of FIG. 9;

FIG. 11 is an alternate perspective view of the heating element module of FIG. 5;

FIG. 12 is a perspective view of the metal endcap secured to one of the open ends of a “U-shaped” SiC heating element, as shown in FIG. 4;

FIG. 13 is an alternate perspective view of the metal endcap of FIG. 12;

Corresponding reference characters indicate corresponding parts throughout the several views of the drawings.

### DETAILED DESCRIPTION

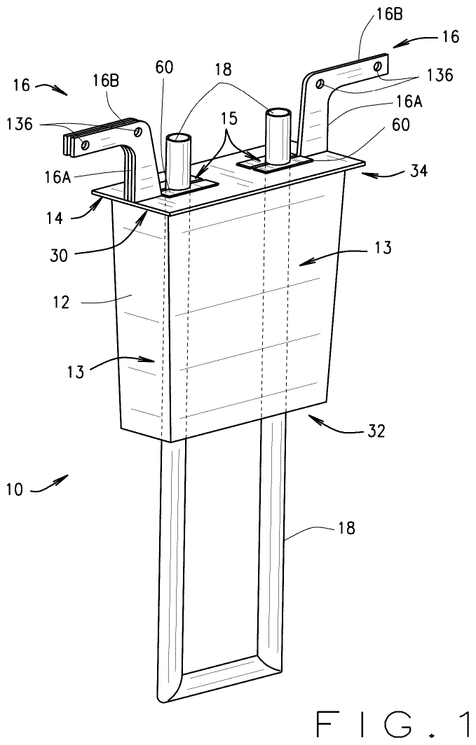

In referring to the drawings, a first embodiment of a representative modular SiC heating element module 10 is shown generally in FIGS. 1-3, where the novel module 10 of the present invention is depicted by way of example. The representative heating element module 10 includes a tapered refractory body or plug 12, a steel mounting support plate 14, a pair of steel support brackets 16, and a “U-shaped” SiC heating element 18.

The refractory body or plug 12 is constructed of rigid refractory materials adapted to withstand temperatures in an electric high temperature furnace. The plug 12 has a somewhat tapered cubic shape, with a rectangular and flat top face 30 having sides approximately fourteen by ten inches long. The plug 12 tapers inward in a uniform downward manner approximately ten to twelve inches to a rectangular and flat bottom face 32 having sides approximately nine by thirteen inches. The top face 30 and the bottom face 32 are parallel to each other. The plug 12 has two parallel and uniformly positioned cylindrical through bores 13. Each through bore 13 is two inches in diameter, extends through the length of the plug 12, and is located approximately three to six inches from its corresponding corner and three to six inches from each nearby edge, with the through bore 13 positioned equidistant from the center of the plug 12.

The mounting support plate 14 is approximately ½ inches thick and generally rectangular, with the long sides having a length of approximately sixteen inches and the short sides having a length of approximately twelve inches. The plate 14 is centered on and securely attached to the top face 30 of the plug 12. In this way, plate 14 uniformly overlaps the top face 30 of the plug 12 to form an overhanging ledge 34, with a uniform width of approximately one inch about the full perimeter of the top face 30 of the plug 12. The plate 14 also has two uniformly positioned through bores 15. Each through bore 15 is two and a half inches in diameter, positioned along a line bisecting the plug 12 lengthwise, and approximately three to six inches and equidistant from its corresponding short side of the plate 14. Thus, as can be appreciated, the two through bores 15 match the two through bores 13 in the refractory plug 12.

The two support brackets 16 each extend upward from opposite sides of the top of the support plate 14. Each of the support brackets 16 is flat, approximately ½ inch thick, and generally “L-shaped,” with a lower leg 16A and an upper leg 16B. One end of the lower leg 16A of each support bracket 16 is welded to the top of the support plate 14. These support brackets 16 are used to lift and lower the heating element module 10 into and out of its furnace.

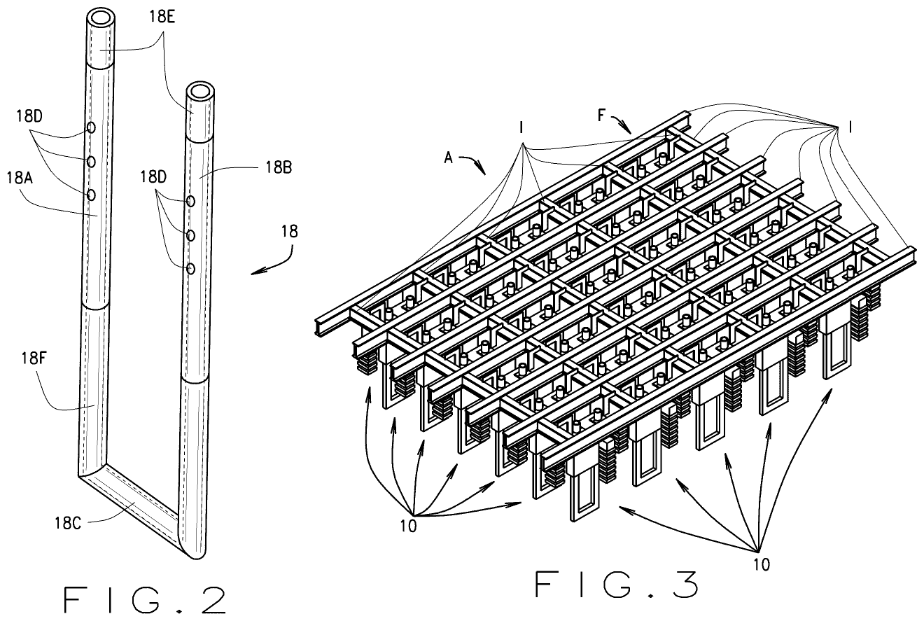

Referring to FIG. 2, it can be seen that the “U-shaped” SiC heating element 18 has a first leg 18A, a second leg 18B that runs parallel to the first leg 18A, and a cross-member 18C. Legs 18A and 18B are each approximately 26.28 inches long, and cross-member 18C is approximately 11.18 inches long. Both legs 18A and 18B, and the cross-member 18C are tubular and have the same uniform inner diameter of approximately one inch and the same uniform outer diameter of approximately 1.73 inches. Each of the upper ends of each of the legs 18A and 18B, designated as 18E, is coated with an electrically conductive material, such as for example aluminum or copper. A portion 18F of the lower end of the element 18, including the cross-member 18C, is sometimes referred to as the “heating length” of the element, and can be coated with a protective SiO2 layer to lengthen the life of the element in harsh furnace environments. Heating element 18 is currently available in the industrial market in a few limited configurations. However, for the purposes of the heating element module 10, the heating element can have a variety of differing configurations so long as they collectively operate together to provide the benefits as outlined herein.

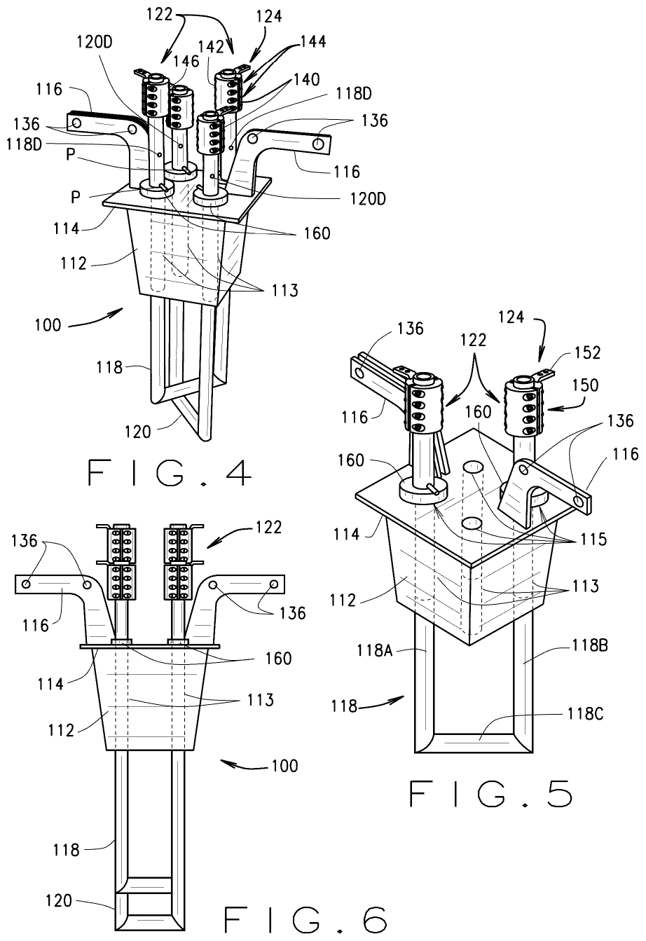

The upper ends of element 18 can be covered by and attached to metal end clamps such as the clamps 122 shown in FIG. 4, which can be used to attach electric cables or wires to each end of element 18.

A ceramic insulative spacer 60 having a flat rectangular surface plate and a cylindrical neck is positioned in each of the through bores 15 in the support plate 14. The neck extends downward into its corresponding through bore 13 in the refractory plug 12. The surface plate of the spacers 60 fit flush against the top of the support plate 14, while the neck of each spacer 60 is shaped and sized to fit snugly into the bores 13 and 15, and fit snugly over the covered portions of the legs 18A and 18B of the heating element 18. As can be appreciated, the spacers 60 separate and insulate heating element 18 from the metal support plate 14.

As can be seen, each of the legs 18A and 18B of the heating element 18 extends upward through one of the two opposing through bores 13 in the refractory plug 12, through its corresponding through bore 15 in the support plate 14, through the neck of its corresponding spacer 60, and upward above the support plate 14. The heating element 18 is held in its desired vertical position by a cotter pin P that is inserted through a set of cross-bores 18D in the side of the legs 18A and 18B (see FIG. 2). This allows the cross-member 18A of heating element 18 to be positioned at a number of heights below the bottom of the plug 12 to provide flexibility in configuring the module for different furnaces and/or furnace applications.

Referring to FIG. 3, it can be seen that sets of the novel high-density electric heating element modules 10 can be arranged in an array, such as for example array A. The array A includes a frame F constructed of steel I-beams I bolted together in a lattice configuration, to which nine heating element modules 10 are attached, and below which the heating elements all hang. As can be appreciated, this set or array A of heating element modules 10 is designed to be lowered into the ceiling of a high temperature furnace (not shown) that has the same number of openings as the number of modules 10, where the openings correspond to, and are shaped and sized to snugly receive, all of the heating element modules 10 of the array A. Of course, such sets or collections of heating element modules 10 can have more or less than nine modules 10, and can be a wide range of shapes, sizes and configurations for specific or tailored furnace configurations and needs.

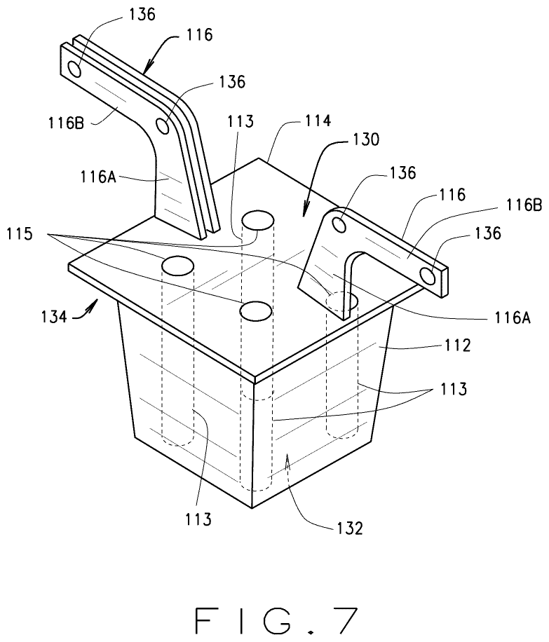

Referring now to FIGS. 4-10, a second representative embodiment of the high-density SiC heating element module of the present invention is shown generally at 100, where the novel module 100 is depicted by way of example. The second representative heating element module 100 includes a tapered refractory body or plug 112, four parallel and uniformly positioned cylindrical through bores 113 in the plug 112, a steel mounting support plate 114, a pair of steel support brackets 116, a first “U-shaped” SiC heating element 118, a second “U-shaped” SiC heating element 120, and a set of four metal end clamps 122 with matching copper wire mount clamps 124.

The refractory body or plug 112 is constructed of rigid refractory materials adapted to withstand temperatures of an electric high temperature furnace. The plug 112 has a somewhat tapered cubic shape, with a square and flat top face 130 having sides approximately sixteen inches long each. The plug 112 tapers inward in a uniform downward manner approximately ten to twelve inches to a square and flat bottom face 132 having sides approximately ten inches long each. The top face 130 and the bottom face 132 are parallel to each other. Each through bore 113 is two inches in diameter, extends through the length of the plug 112, and located approximately 1.7 inches from its corresponding corner and ½ inch from each nearby edge.

The mounting support plate 114 is approximately ½ inch thick and generally square, with sides approximately sixteen inches long each. The plate 114 is centered on and securely attached to the top face 130 of the plug 112. In this way, plate 114 uniformly overlaps the top face 130 of the plug 112 to form an overhanging ledge 34, with a uniform width of two inches about the full perimeter of the top face 130 of the plug 112. The plate 114 also has four uniformly positioned through bores 115. Each through bore 115 is 2½ inches in diameter, and located approximately 4½ inches from its corresponding corner and 4½ inches from each nearby edge. Thus, as can be appreciated, the four through bores 115 match the four through bores 113 in the refractory plug 112.

The two support brackets 116 each extend upward from opposite sides of the top of the support plate 114. Each of the support brackets 116 is flat, approximately ½ inch thick, and generally “L-shaped,” with a lower leg 116A and an upper leg 116B. One end of the lower leg 116A of each support bracket 116 is welded to the top of the support plate 114. A pair of through bores or lifting eyes 136 are cut or formed in each support bracket 116; one near the end of the upper leg 116B opposite the lower leg 116A, and one at the elbow between each of the legs, 116A and 116B. These lifting eyes 136 are used to lift and lower the heating element module 100 into and out of its furnace, and are also used to secure the blocks together.

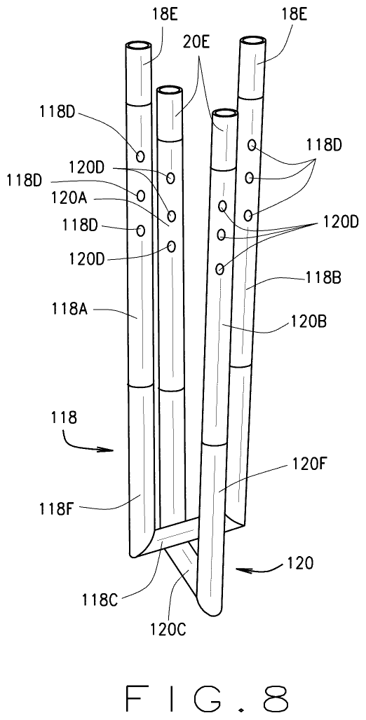

Referring to FIG. 8, it can be seen that the first “U-shaped” SiC heating element 118 has a first leg 118A, a second leg 118B that runs parallel to the first leg 118A, and a cross-member 118C. Legs 18A and 18B are each approximately 26.28 inches long, and cross-member 18C is approximately 11.18 inches long. Both legs 118A and 118B, and the cross-member 118C are tubular and have the same uniform inner diameter of approximately one inch and the same uniform outer diameter of approximately 1.73 inches. Each of the legs 118A and 118B has a set of three cross-bores 118D, where each of the cross-bores 118D is positioned at a different height along the legs 118A and 118B (see FIG. 8). The second “U-shaped” SiC heating element 120 has a first leg 120A, a second leg 120B that runs parallel to the first leg 120A, and a cross-member 120C. Legs 120A and 120B are each approximately 26.28 inches long, and cross-member 120C is approximately 11.18 inches long. Both legs 120A and 120B, and the cross-member 120C have the same uniform inner diameter of approximately one inch and the same uniform outer diameter of approximately 1.73 inches. Each of the legs 120A and 120B has a set of three cross-bores 120D, where each of the cross-bores 120D is positioned at a different height along the legs 120A and 120B (see FIG. 8). Each of the upper ends of each of the legs 118A and 118B, designated as 118E, is coated with an electrically conductive material, such as for example aluminum or copper. A portion 118F of the lower end of the element 118, including the cross-member 118C, is coated with a protective SiO2 layer to lengthen the life of the element in harsh furnace environments. Similarly, each of the upper ends of each of the legs 120A and 120B, designated as 120E, is coated with an electrically conductive material, such as for example aluminum or copper. A portion 120F of the lower end of the element 120, including the cross-member 120C, is coated with a protective SiO2 layer to lengthen the life of the element in harsh furnace environments. In embodiment 100, the first and second heating elements 118 and 120 are identical, and are currently available in the industrial market in limited configurations. However, for the purposes of the heating element module 100, the first and second heating elements can have a variety of differing configurations so long as they collectively operate together to provide the benefits as outlined herein.

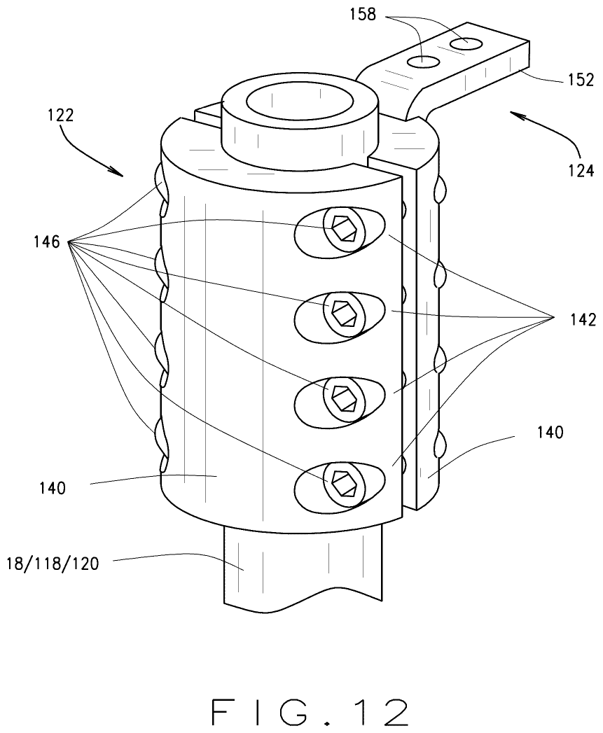

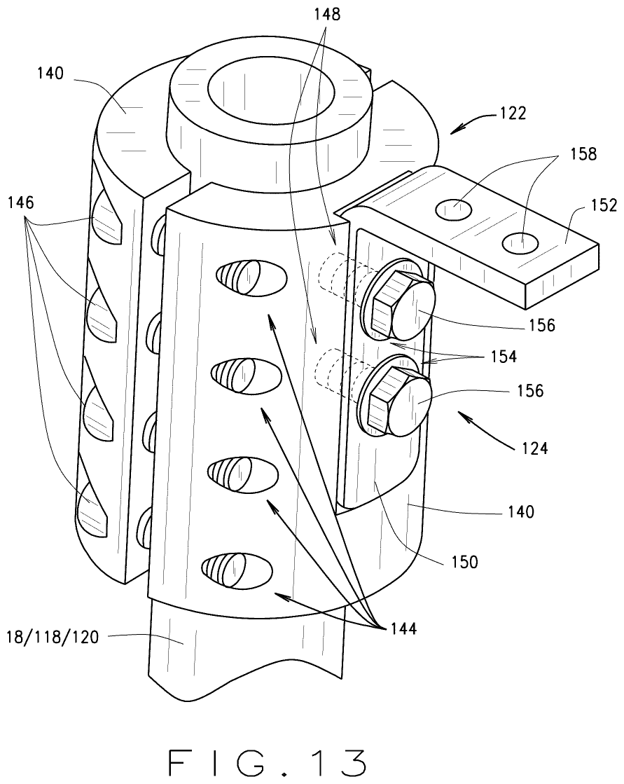

Referring to FIGS. 12 and 13, it can be seen that each end of each of the elements 118 is covered by and attached to one of the four corresponding metal end clamps 122. Each of the end clamps 122 consists of two matching and mating half-shells 140, which are formed of a highly conductive metal or alloy, such as for example aluminum or copper. Each half-shell 140 has a uniform inner radius of approximately 0.80 inches and a length of approximately four inches. Each half-shell 140 has a set of four identical through-bores 142 positioned along one of its straight edges or sides, and a set of four identical smaller threaded bores 144 positioned along its opposite edge or side. The through bores 142 are each shaped and sized to slidingly receive one of a set of eight fastening screws 146, and the threaded bores 144 are each shaped and sized to threadingly receive the screws 146. The through bores 142 of one half-shell 140 align with the threaded bores 144 of a sister or “mated” half-shell 140 when the two half-shells 140 are positioned together as shown. In this way, as can be appreciated, a matching pair of half-shells 140 can be positioned about the end of one of the legs 118A or 118B of a given heating element 118, where the screws 146 can be used to run through the through bores 142 and thread into the threaded bores 144, so as to secure the half-shells 140 onto the heating element 118 to form one of the cylindrical clamps 122. Each of the half-shells 140 also has a pair threaded bores 148 positioned along its curved surface.

Each of the end clamps 122 is attached to one of the four corresponding copper wire mount clamps 124. Each wire mount clamp 124 is constructed of a flat, rectangular copper bar approximately one inch wide, 5½ inches long and ¼ inch thick. The mount clamps 124 are each bent across the middle to form a first attachment leg 150 that is 3¼ inches long and a second attachment leg 152 that is 2¼ inches long, which together form an “L-shape.” The first attachment leg 150 has two holes or through bores 154 that match the threaded bores 148 in the half-shells 140 such that screws 156, which mate with the threaded bores 148, can be used to secure the first attachment leg 150 to a selected half-shell 140. The second attachment leg 152 has one or more through bores 158 for attachment to an electric cable or wire.

A cylindrical ceramic insulative spacer 160 is positioned in each of the through bores 115 in the support plate 114. Each spacer 160 has a neck that extends downward into each corresponding through bore 113 in the refractory plug 112. The top of the spacers 160 fit flush against the top of the support plate 114, while the neck of each spacer is shaped and sized to fit snugly into the bores 113 and 115, and fit snugly over the covered portions of the legs 118A, 118B, 120A and 120B of the heating elements 118 and 120. As can be appreciated, the spacers 160 separate and insulate the heating elements 118 and 120 from the metal support plate 114.

As can be seen, each of the legs 118A and 118B of the first heating element 118 extends upward through one of the two opposing through bores 113 in the refractory plug 112, through its corresponding through bore 115 in the support plate 114, through the neck of its corresponding spacer 160, and upward above the support plate. The first heating element 118 is held in its desired vertical position by a cotter pin P that is inserted through a matching pair of the cross-bores 118D in the sides of the legs 118A and 118B (see FIGS. 1, 2 and 8). Similarly, each of the legs 120A and 120B of the second heating element 120 extends upward through one of the two opposing through bores 113 in the refractory plug 112, through its corresponding through bore 115 in the support plate 114, through the neck of its corresponding spacer 160, and upward above the support plate 114. However, legs 120A and 120B only extend approximately 9¾ inches above the support plate 114, while legs 118A and 118B extend further above the support plate 114—approximately 133/4 inches. In this way, the cross-member 120C extends downward further from the face 132 than the cross-member 118C, such that the cross-members 118C and 120C are separated by a distance of approximately four inches. This allows the heating elements 118 and 120 to produce nearly twice the heat flux in the same area as a traditional single-element configuration.

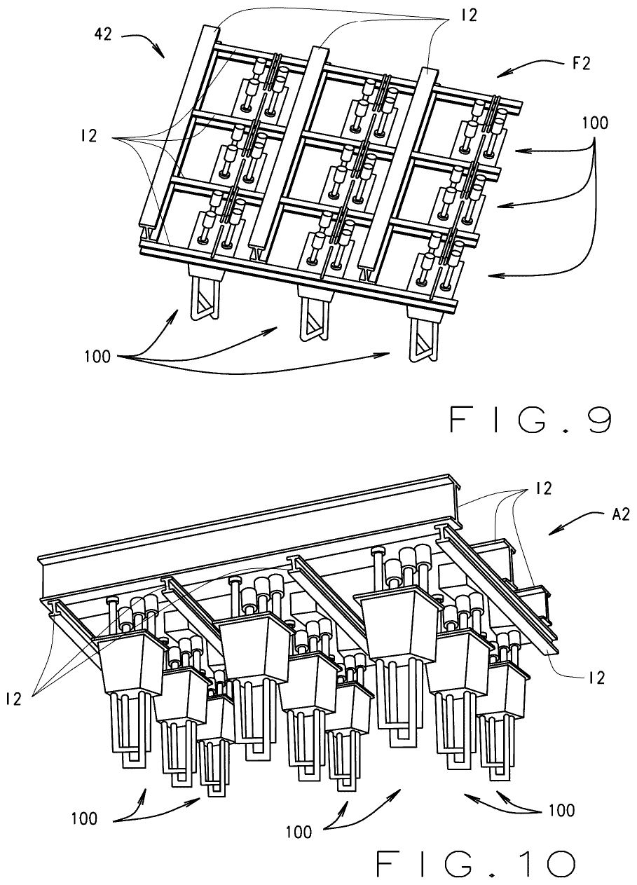

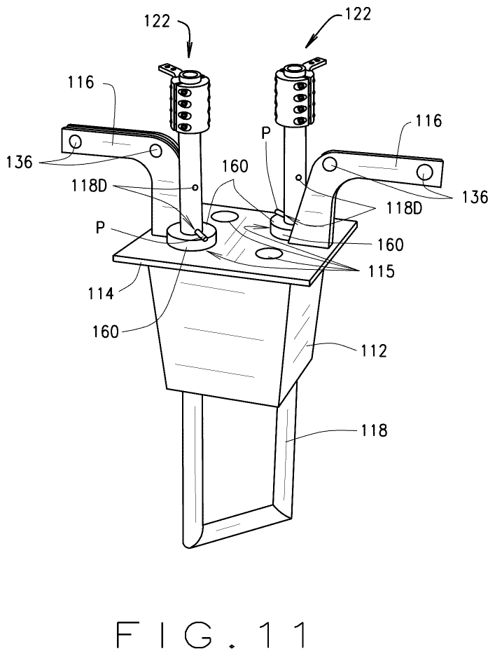

Referring to FIGS. 9 and 10, it can be seen that sets of the novel high-density electric heating element modules 100 can be arranged in an array, such as for example array A2. The array A2 includes a frame F2 constructed of multiple steel I-beams 12 bolted or welded together in a lattice configuration, to which nine heating element modules 100 are attached, and below which the heating elements all hang. As can be appreciated, this set or array A2 of heating element modules 100 is designed to be lowered into the ceiling of a high temperature furnace (not shown) that has the same number of openings as the array A2, where the openings correspond to, and are shaped and sized to snugly receive, all of the heating element modules 100 of the array A2. Of course, such sets or collections of heating element modules 100 can have more or less than nine modules 100, and can be a wide range of shapes, sizes and configurations for specific or tailored furnace configurations and needs.

FIG. 11 shows heating element module 100 in an alternate configuration in which the module 100 only includes only a single heating element, i.e., heating element 118. Refractory or metal plugs (not shown) can be placed in the open through bores 115.

While we have described in the detailed description a configuration that may be encompassed within the disclosed embodiments of this invention, numerous other alternative configurations, that would now be apparent to one of ordinary skill in the art, may be designed and constructed within the bounds of our invention as set forth in the claims. Moreover, the above-described novel high-density electric heating element modules 10 and 100 for a high temperature furnace of the present invention can be arranged in a number of other and related varieties of configurations without expanding beyond the scope of our invention as set forth in the claims.

For example, the SiC elements 18, 118 and 120 need not have the specific shape(s) depicted in the Figures. Rather, these elements can take on virtually any shape so long as they can provide an acceptable heating profile and can be fitted into a modular housing, such as for example, the plug 12.

Similarly, the plug 12 need not have the specific configuration depicted in the Figures. Rather, the plug 12 can be of any variety of shapes and sizes, so long as it can be positioned in a modular array and is configured to hold one or more SiC elements 18, 118 and/or 120.

In addition, the modules 10 and 100 need not be limited to one or two SiC heating elements. Rather, each module may incorporate any number of SiC heating elements, so long as

. By way of further example, the arrays F and F2 need not have the specific configuration depicted in the Figures. For example, the arrays may have more or fewer modules 10 and/or 100. The spacing of the modules 10 and 100 in the arrays F and F2 can vary depending on operational demands and the operational specifications of the elements 18, 118 and 120. Further, the modules 10 and 100 may be positioned in any vertical or horizontal position in the arrays F and F2 and the arrays can be multi-planar—so long as the arrays and modules provide the performance required in this disclosure.

Also, the tops 18E, 118E and 120E need not be coated or may be coated by a variety of conductive materials. In addition, such coatings can be placed on differing lengths of the elements 18, 118 and 120, and need not cover the full circumference of the element end.

As a further example, the steel support brackets 116 need not have the specific configuration shown. Rather, the brackets 116 can be of virtually any shape and size so long as they can provide a means to secure the module 10 and/or 100 in an array, such as F or F2, as required by this disclosure. However, it is also recognized that, for example, the modules 10 and 100 need not have any support brackets 116 if the steel plate 14 can provide adequate support for the modules in an array, such as F or F2.

In addition, the positioning and orientation of the elements 18, 118 and/or 120 in the modules 10 and/or 100 is not limited to what is shown in the Figures. Rather, the elements 18, 118 and 120 can be positioned higher or lower in the plug 12, and they may be oriented at different positioned across the top and bottom of the plug. Also, the separation between the elements 118 and 120 can be smaller or greater than what is depicted.

Further, the wire mount clamps 124 can be virtually any shape, size and configuration, so long as they are able to secure to the elements 18, 118 and/or 120, attach to an electrical power cable or supply wire, and can convey the electricity from the supply wire to the element to which it is attached. Moreover, the wire mount clamps 124 and the elements 18, 118 and 120 can be mutually configured to attach together at a position along the length of the element other than the top of the element.

Additional variations or modifications to the configuration of the above-described novel high-density electric heating element modules 10 and 100 for a high temperature furnace of the present invention may occur to those skilled in the art upon reviewing the subject matter of this invention. Such variations, if within the spirit of this disclosure, are intended to be encompassed within the scope of this invention. The description of the embodiments as set forth herein, and as shown in the drawings, is provided for illustrative purposes only and, unless otherwise expressly set forth, is not intended to limit the scope of the claims, which set forth the metes and bounds of our invention.

What is claimed is:

1. A heating element module for a high temperature furnace, said furnace having a heated process zone, a ceiling with an inner face and a sidewall with an inner face, both of said inner faces being exposed at least in part to said process zone, said heating element module comprising:
a. a first electric heating element, said first electric heating element comprising a resistive metal having a covered portion and an exposed portion, said exposed portion generating heat when an electric current is directed across said first electric heating element;
b. a second electric heating element, said second electric heating element comprising a resistive metal and having a covered portion and an exposed portion, said exposed portion generating heat when an electric current is directed across said second electric heating element; and
c. a body, said body comprising a refractory material and attaching to one of said furnace ceiling and said furnace sidewall, said body holding at least in part said first electric heating element such that said first element exposed portion is exposed at least in part to said furnace process zone when said body is attached to one of said furnace ceiling and said sidewall, said body further holding at least in part said second electric heating element covered portion such that said second element exposed portion is exposed at least in part to said furnace process zone when said body is attached to one of said furnace ceiling and said sidewall, said first electric heating element exposed portion being separated from said second electric heating element exposed portion.

2. The heating element module of claim 1, wherein said furnace further has an opening in one of said ceiling and said sidewall, and said body is shaped and sized for releasable placement in said opening.

3. The heating element module of claim 2, wherein said body is at least in part tapered to fit into said furnace opening.

4. The heating element module of claim 1, wherein said first heating element exposed portion is at least in part rod-shaped.

5. The heating element module of claim 1, wherein at least a portion of said first heating element exposed portion horizontally overlaps at least a portion of said second heating element exposed portion.

6. The heating element module of claim 1, wherein said first heating element exposed portion comprises Silicon Carbide.

7. The heating element module of claim 1, wherein said first heating element exposed portion has a U-shape.

8. The heating element module of claim 7, wherein said second heating element exposed portion has a U-shape.

9. The heating element module of claim 8, wherein said first heating element exposed portion extends at least in part horizontally over said second heating element exposed portion.

10. The heating element module of claim 1, wherein said first heating element covered portion is embedded at least in part in said body.

11. A heating element module for a high temperature furnace, said furnace having a heated process zone, a ceiling with an inner face and a sidewall with an inner face, both of said inner faces being exposed at least in part to said process zone, said heating element module comprising:
a. a first electric heating element, said first heating element comprising a resistive metal having a covered portion and an exposed portion, said exposed portion generating heat when an electric current is directed across said first heating element, said first heating element being generally “U-shaped” with a first leg and a second leg and a cross-member there between, said cross-member comprising at least in part said exposed portion; and
b. a body, said body comprising a refractory material and attaching to one of said ceiling and said sidewall, said body fitting snugly and releasably into a corresponding opening in said one of said ceiling and said sidewall, said body holding at least in part one of said first and second legs of said first heating element with said cross-member being exposed at least in part to said furnace process zone when said body is positioned in said opening.

12. The heating element module of claim 11, wherein said first heating element covered portion is embedded at least in part in said body.

13. The heating element module of claim 11, further comprising a second electric heating element, said second heating element being separated from said first heating element, said second heating element comprising a resistive metal having a covered portion and an exposed portion, said exposed portion generating heat when an electric current is directed across said second heating element, said second heating element being generally “U-shaped” with a first leg and a second leg and a cross-member there between, said cross-member comprising at least in part said exposed portion, said body holding at least in part one of said first and second legs of said second heating element with said cross-member being exposed at least in part to said furnace process zone when said body is positioned in said opening.

14. The heating element module of claim 13, wherein at least a portion of said first heating element exposed portion horizontally overlaps at least a portion of said second heating element exposed portion.

15. The heating element module of claim 11, wherein said first heating element exposed portion comprises Silicon Carbide.

16. A heating element array for a high temperature furnace, said furnace having a heated process zone, a ceiling with an inner face and a sidewall with an inner face, both of said inner faces being exposed at least in part to said process zone, said heating element array comprising:
a. two or more heating element modules, each said module comprising a first electric heating element and a refractory body, said first heating element comprising a resistive metal having a covered portion and an exposed portion, said body housing at least in part said first heating element, said exposed portion extending out of said body and generating heat when an electric current is directed across said first heating element; and
b. a frame, said frame being adapted to fit at least in part inside said furnace, said frame supporting said two or more modules such that said exposed portion of at least one of said first heating elements is exposed to said process zone when said frame is positioned in said furnace, at least one of said two or more modules being releasable from said frame.

17. The heating element array of claim 16, wherein at least one of said two or more modules further comprises a second electric heating element, said second heating element comprising a resistive metal having a covered portion and an exposed portion, said exposed portion generating heat when an electric current is directed across said second heating element, said body housing at least in said second heating element with said second heating element exposed portion being exposed at least in part to said furnace process zone, said second heating element being spaced apart from said first heating element.

18. The heating element array of claim 17, wherein said exposed portions of at least one of said first heating elements and one of said second heating elements overlap each other.

19. is generally “U-shaped” with a first leg and a second leg and a cross-member there between, said cross-member comprising at least in part said exposed portion.

20. The heating element array of claim 16, wherein at least one of said first heating elements is generally “U-shaped” with a first leg and a second leg and a cross-member there between, said cross-member comprising at least in part said exposed portion.

21. The heating element array of claim 16, wherein said furnace has an opening in one of said ceiling and said sidewall, and wherein said frame mates at least in part with said opening.
